(19) United States
(12) Patent Application Publication
(10) Pub. No.: US 2012/0075565 A1
(43) Pub. Date: Mar. 29, 2012

(54) LIQUID CRYSTAL DISPLAY DEVICE

(75) Inventors: Yasuyoshi Kaise, Osaka (JP); Yasutoshi Tasaka, Osaka (JP)

(73) Assignee: SHARP KABUSHIKI KAISHA, Osaka (JP)

(21) Appl. No.: 13/319,797

(22) PCT Filed: Feb. 26, 2010
(86) PCT No.: PCT/JP10/53090

§ 371 Date: Nov. 14, 2011

(30) Foreign Application Priority Data
May 12, 2009 (JP) 2009-115971

(51) Int. Cl. G02F 1/1343

(52) U.S. Cl. 349/139

(57) ABSTRACT

The present invention provides a liquid crystal display device that can control the alignment of liquid crystal molecules more reliably and also can suppress the deterioration of the contrast characteristics and a reduction in transmittance without complicating the manufacturing process of a matrix substrate. Specifically disclosed is a liquid crystal display device including a pair of substrates (110 and 130) and a liquid crystal layer held between the pair of substrates. One of the pair of substrates has pixel electrodes (113). The other of the pair of substrates has a first opposite electrode (132), an insulating layer (133) formed on the first opposite electrode, and a second opposite electrode (134) formed on the insulating layer. The second opposite electrode has an opening (137), and the opening overlaps at least with a pixel when the pair of substrates are observed in a plan view, and the first opposite electrode overlaps at least with part of said opening in the pixel when the pair of substrates are observed in a plan view.

### TECHNICAL FIELD

The present invention relates to a liquid crystal display device. More particularly, the present invention relates to a liquid crystal display device suitable as a mid- and small-sized liquid crystal display device.

### BACKGROUND ART

Multi-domain vertical alignment mode liquid crystal display devices (hereinafter referred to as “MVA-LCD”) are known. In this type of display device, liquid crystal molecules having negative dielectric constant anisotropy are vertically aligned, and alignment control structures, which are ridges (linear protrusions) on the substrate and/or openings (slits) in the electrode, are provided. Because an MVA-LCD includes alignment control structures, liquid crystal alignment upon voltage application can still be controlled in multiple directions even if rubbing treatment is not performed. Also, MVA-LCDs are superior to conventional TN (Twisted Nematic) type LCDs in the viewing angle characteristics.

However, conventional MVA-LCDs only provide low white luminance and dark displays, and therefore have a room for improvement. The main cause of this problem is dark lines generated in areas above the protrusion and/or the slits, which are borders of alignment divisions. These dark lines reduce the transmittance during the white display and darken the display. Providing greater spacings between the protrusions and/or between the slits can solve this problem, but this solution results in reduced number of protrusions and/or slits, which are alignment control structures. As a result, it takes longer time for the alignment to stabilize after the prescribed voltage is applied on the liquid crystal layer, which slows down the response speed.

An effective technology addressing this issue and providing a high-luminance and fast-responding MVA-LCD is the one that provides a pretilt angle for liquid crystal molecules by using a polymer (hereinafter also referred to as “pretilt angle provision technology”). In the pretilt angle provision technology, a liquid crystal composition, which is a liquid crystal material mixed with polymerizable components such as monomers and oligomers, is sealed in between the substrates. The polymerizable components are polymerized while a voltage is applied across the substrates to tilt the liquid crystal molecules. This technology provides a liquid crystal layer in which liquid crystal molecules are tilted to prescribed directions upon voltage application, and the directions in which the liquid crystal molecules are tilted are thus regulated. The polymerizable components selected here are usually those polymerized by heat or light (ultraviolet ray).

Regarding the pretilt angle provision technology, as a technology for obtaining a wider viewing angle and a shorter response time for the middle tones, a liquid crystal display device is disclosed (see Patent Document 1, for example), which includes two substrates facing each other, a liquid crystal layer sealed in between the substrates and containing a polymer that regulates the pretilt angle and/or inclination angle of the liquid crystal molecules at the time of driving, electrodes respectively disposed on the two substrates for voltage application on the liquid crystal layer, and a plurality of stripe-shaped patterns in least one of the electrodes, the strip-shaped patterns having a width that is greater than the spaces therebetween, and being arranged periodically to make the liquid crystal molecules arranged in the longitudinal directions of the patterns when the polymerizable component mixed in the liquid crystal layer is polymerized under a voltage. FIG. 4 and the like in Patent Document 1 disclose fishbone-shaped electrode patterns. FIG. 15 and the like in Patent Document 1 disclose a technology that does not form any spaces in the pixel electrode, but forms 0.3 μm-high linear protrusions made of dielectric material on the pixel electrode.

### RELATED ART DOCUMENTS

### Patent Documents

Patent Document 1: Japanese Patent Application Laid-Open Publication No. 2003-149647

### SUMMARY OF THE INVENTION

### Problems to be Solved by Invention

For liquid crystal displays, particularly for mid- to small-sized liquid crystal displays, panels of higher transmittance are in demand from the perspective of higher visibility and better energy saving. By forming a fishbone-shaped electrode pattern described in Patent Document 1, better response characteristics and viewing angle characteristics and the like can be obtained compared to the case in which liquid crystals are aligned using structures such as rivets. However, the effective voltage applied on the liquid crystal layer is reduced in the regions where the electrode is not present (i.e., spaces), and therefore the transmittance in those regions becomes low.

On the other hand, when linear protrusions made of a dielectric material are formed, the transmittance reduction can be suppressed. However, in this case, the tilting direction of the liquid crystal molecules cannot be regulated reliably, and as a result, the alignment of the liquid crystal molecules may not sufficiently be controlled. Also, because the dielectric material must have a certain film thickness, an uneven surface is formed due to the presence of the dielectric material, creating a spot for light leakage. This sometimes resulted in deteriorated contrast characteristics. Further, since the linear protrusions made of a dielectric material are formed on pixel electrodes, the manufacturing process of the matrix substrate becomes complex.

The present invention was devised in consideration of the current issues described above, and is aiming at providing a liquid crystal display device that can reliably control the alignment of the liquid crystal molecules and can also suppress the deterioration of the contrast characteristics and the reduction in the transmittance without complicating the process of manufacturing the matrix substrate.

### Means for Solving the Problems

In the quest for a liquid crystal display device that can reliably control the alignment of the liquid crystal molecules and also can suppress the deterioration of the contrast characteristics and reduction in transmittance without complicating the process of manufacturing the matrix substrate, the inventors of the present invention focused on not the substrate on which pixel electrodes are disposed (i.e., matrix substrate), but on the substrate on which the opposite electrode is disposed (i.e., opposite substrate). The inventors found that by providing the opposite substrate with a first opposite electrode, an insulating layer covering the first opposite electrode, and a second opposite electrode formed on the insulating layer on the side facing the liquid crystal layer, by forming openings in the second electrode at least in the region overlapping the pixels, and further by superimposing the first opposite electrode with at least a part of the openings located in pixels, (1) alignment can be controlled by an electrical field, because when the polymerizable component in the liquid crystal composition is polymerized, a voltage can be applied on the second opposite electrode in which openings are formed, (2) the second opposite electrode can be made thinner than the linear protrusions made of a dielectric material, and (3) the effective voltage applied on the liquid crystal layer is higher than in the case where fishbone-shaped electrode patterns are formed, because a voltage can be applied on the first opposite electrode and the second opposite electrode after the polymerizable component in the liquid crystal composition is polymerized. As a result, the above-mentioned problems have been admirably solved, leading to completion of the present invention.

That is, provided is a liquid crystal display device including a pair of substrates and a liquid crystal layer held between the pair of substrates, wherein one of the pair of substrates has pixel electrodes and the other of the pair of substrates has a first opposite electrode, an insulating layer formed on the first opposite electrode, and a second opposite electrode formed on the insulating layer; the second opposite electrode has an opening, and the openings overlap at least a pixel when the pair of substrates are observed in a plan view; and the first opposite electrode overlaps at least part of the opening in the pixel when the pair of substrates are observed in a plan view.

As long as these constituting elements are included as essential components, the configuration of the liquid crystal display device of the present invention is not particularly limited by other constituting elements.

Preferred embodiments of the liquid crystal display device of the present invention are described in detail below. Each of the embodiments described below can be combined as appropriate.

The first opposite electrode preferably overlaps the entire opening in the pixel when the pair of substrates are observed in a plan view. This configuration can further improve the transmittance.

The first opposite electrode is preferably sheet-shaped. With this first opposite electrode, the manufacturing process is prevented from having extra production steps. Also, any pattern misalignment between the first opposite electrode and the second opposite electrode can be suppressed from occurring.

The liquid crystal display device of the present invention is particularly preferable when the following features are included.

That is, the aforementioned opening preferably includes a plurality of slits.

Also, the second opposite electrode preferably includes a trunk portion formed along the border between adjacent pixels and a plurality of branch portions branching off from the trunk portion. The plurality of slits and the plurality of branch portions are preferably arranged alternately.

The liquid crystal mode of the aforementioned liquid crystal display device is preferably the vertical alignment mode.

The aforementioned liquid crystal layer preferably contains nematic liquid crystal molecules having negative dielectric constant anisotropy.

Preferably, the aforementioned pair of substrates has a polymer formed thereon, on the sides facing the liquid crystal layer, and the polymer is formed by polymerizing the polymerizable component added to the liquid crystal layer while a voltage is applied on the liquid crystal layer.

### Effects of the Invention

According to the liquid crystal display device of the present invention, alignment of liquid crystal molecules can be controlled more reliably and the deterioration of the contrast characteristics and reduction in transmittance can be suppressed without complicating the manufacturing process of the matrix substrate.

### BRIEF DESCRIPTION OF THE DRAWINGS

FIG. 1 schematically shows a liquid crystal display device according to Embodiment 1. FIG. 1(a) is a plan view, and FIG. 1(b) is a cross-sectional view taken along the line X-Y of FIG. 1(a).

### DETAILED DESCRIPTION OF EMBODIMENTS

In this specification, the 3 o'clock direction, 12 o'clock direction, 9 o'clock direction, and 6 o'clock direction when the display surface of the liquid crystal display device is observed in a plan view are defined as 0° direction, 90° direction, 180° direction, and 270° direction, respectively.

Below, although embodiments are described to explain the present invention further in detail with reference to figures, the present invention is not limited to these embodiments.

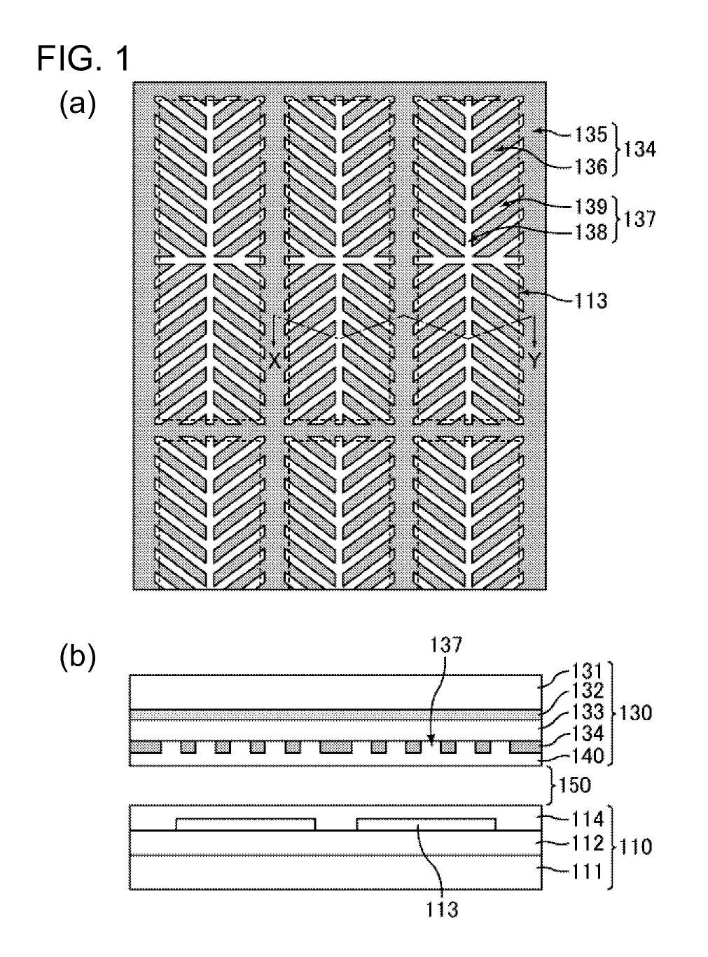

As shown in FIG. 1, the liquid crystal display device of the present embodiment is a vertical alignment mode liquid crystal display device having a matrix substrate 110 disposed on the back side, an opposite substrate 130 disposed on the viewer's side and is bonded to the matrix substrate 110 with a sealing member, and a liquid crystal layer 150 sealed in the space between the matrix substrate 110 and the opposite substrate 130. The matrix substrate 110 and the opposite substrate 130 are held apart by a prescribed space (cell gap) by spacers (not shown) formed on the opposite substrate 130.

The liquid crystal layer 150 is held by the matrix substrate 110 and the opposite substrate 130, which are disposed facing each other, and contains nematic liquid crystal material having negative dielectric constant anisotropy. The liquid crystal layer 150 is approximately vertically aligned initially. That is, when no voltage is applied, the nematic liquid crystal molecules contained in the liquid crystal layer 150 (hereinafter may be simply referred to as “liquid crystal molecules”) are aligned approximately perpendicular to the substrates 110 and 130. When the voltage is applied, the liquid crystal molecules, in particular those in the middle layer of the liquid crystal layer 150, are oriented approximately horizontal to the substrates 110 and 130. Thus, the liquid crystal display device of the present embodiment is a vertical alignment (VA) mode liquid crystal display device. In the present embodiment, the liquid crystal alignment angle is regulated by the pretilt angle provision technology.

On the matrix substrate 110 and the opposite substrate 130, linear polarizing plates (not shown) are each disposed in the “Cross Nicol” arrangement on the sides away from the liquid crystal layer 150 (outer sides). Thus, the liquid crystal display device of the present embodiment is a normally black mode (the mode in which the transmittance or luminance in OFF state is lower than that in ON state) liquid crystal display device. Also, a backlight (not shown) is installed behind the linear polarizing plate disposed on the matrix substrate 110.

The liquid crystal display device of the present invention may be a normally white mode (the mode in which the transmittance and luminance in OFF state is higher than that in ON state) device, but is preferably a normally black mode device in order to achieve a high contrast ratio.

The opposite substrate 130 includes a glass substrate 131, a colored layer (not shown) and a black matrix (not shown) formed on the glass substrate 131 on the side facing the liquid crystal layer 150, a first opposite electrode 132 formed on the colored layer and the black matrix, an insulating layer 133 that covers the first opposite electrode 132, a second opposite electrode 134 formed on the insulating layer 133 and insulated from the first opposite electrode 132, a vertical alignment film 140 that covers these members, and spacers selectively formed in the light shielding regions (regions from which the light is blocked by a light shielding member such as the black matrix) on the vertical alignment film 140, in this order. Also, on the vertical alignment film 140, a polymer (not shown) that regulates the pretilt angle of the liquid crystal molecules is provided on the side facing the liquid crystal layer 150.

The insulating layer 133 is made of a dielectric material (insulating film) such as SiNx or SiO₂. The film thickness of the insulating layer 133 is preferably 0.05 to 0.5 (more preferably, 0.1 to 0.3) μm. If the film thickness is less than 0.05 μm, insulation failure due to pin holes and the like may be inclined to occur. On the other hand, if the film thickness exceeds 0.5 μm, the transmittance may be reduced significantly, which is unfavorable.

The first opposite electrode 132 and the second opposite electrode 134 are the common electrodes commonly provided for all pixels (all picture elements for color displays) to drive the liquid crystal layer 150, and are made of transparent conductive films such as ITO or IZO. The film thickness of the first opposite electrode 132 is preferably 0.05 to 0.3 (more preferably 0.1 to 0.2) μm. If the film thickness is less than 0.05 μm, faulty disconnection may be inclined to occur. On the other hand, if the film thickness exceeds 0.3 μm, the transmittance may be reduced significantly, which is unfavorable. The film thickness of the second opposite electrode 134 is 0.05 to 0.3 (more preferably 0.1 to 0.2) μm. If the film thickness is less than 0.05 μm, faulty disconnection may be inclined to occur. On the other hand, if the film thickness exceeds 0.3 μm, the transmittance may be reduced significantly, and a surface unevenness is formed due to the presence of the second opposite electrode 134, creating a spot for light leakage. This sometimes results in deteriorated contrast characteristics, which is unfavorable.

The colored layer and the black matrix are formed of a colored resin such as acrylic resin or the like containing pigments. The vertical alignment film 140 is formed of a polyimide resin. The spacers are made of a resin such as acrylic resin.

On the other hand, the matrix substrate 110 has a glass substrate 111; an insulating layer (interlayer insulating film) 112 formed on the glass substrate 111 on the side facing the liquid crystal layer 150; pixel electrodes 113 (regions indicated with dotted lines in FIG. 1(a)) formed on the insulating layer 112; and a vertical alignment film 114 covering these members, in this order. Also, a polymer (not shown) that regulates the pretilt angle of the liquid crystal molecules is disposed on the vertical alignment film 114 on the side facing the liquid crystal layer 150.

The insulating layer 112 is formed of a dielectric material (insulating film) such as acrylic resin. A pixel electrode 113 is provided for each of the pixels (picture elements in the case of color displays) to drive the liquid crystal layer 150, and is formed of a transparent conductive film such as ITO. The vertical alignment film 114 is formed of a polyimide resin.

The matrix substrate 110 has TFTs, which are switching elements (not shown; hereinafter may be referred to as “pixel switching TFTs”), gate wirings (not shown), source wirings (not shown), drain electrodes (not shown), auxiliary capacitance wirings (not shown) and the like between the glass substrate 111 and the insulating layer 112. The gate wirings, source wirings, and drain electrodes are connected to the pixel switching TFTs, and the pixel electrode 113 is connected to a drain electrode through a contact hole (not shown) provided in the insulating layer 112.

The pixel electrode 113 has a simple rectangular shape when observed in a plan view, and is provided for respective pixels. Thus, the region where a pixel electrode 113 is provided approximately corresponds to a pixel region, and each pixel is formed into a rectangular shape. Also, the first opposite electrode 132 is a sheet-shaped when observed in a plan view (planar electrode) formed to cover all the pixels, i.e., at least the entire display region. Thus, the pixel electrode 113 and the first opposite electrode 132 have the same shapes as the pixel electrode and the opposite electrode, respectively, provided in a typical TN mode liquid crystal display device or the like.

On the other hand, the second opposite electrode 134 has trunk portions 135 that extend along the borders between neighboring pixels and are formed in lattice when observed in a plan view, and branch portions 136 that extend (branch off) from the trunk portions 135 to form stripes extending in oblique directions (45°, 135°, 225°, and 315° directions, for example).

As a result, the second opposite electrode 134 has openings each formed for respective pixels. An opening is formed at least in regions that overlap respective pixels when the substrates 110 and 130 are observed in a plan view. More specifically, an opening is constituted of fishbone-shaped slits 137, and the slits 137 are formed in the opening region of each pixel (the transmissive region excluding the light-shielding region) when substrates 110 and 130 are observed in a plan view. Thus, a pixel (picture element in the case of color displays) usually corresponds to a pixel opening region (the transmissive region excluding the light-shielding region; picture element opening region for color displays). The slit 137 includes a trunk slit 138 and branch slit 139. Trunk slit 138 is a cross-shaped slit, and divides each pixel, which is rectangular when observed in a plan view, into four identical rectangular segments. Branch slit 139 is a stripe-shaped slit extending from the trunk slit 138 in oblique directions (45°, 135°, 225°, and 315° directions, for example). The branch slits 139 and branch portions 136 are arranged alternately.

Consequently, the first opposite electrode 132 is present under the slit 137 of the second opposite electrode 134 (on the side facing the glass substrate 131). That is, the first opposite electrode 132, which is planar in a plan view, is disposed such that it fills the slits 137 of the second opposite electrode 134 when the substrates 110 and 130 are observed in a plan view.

The width (the shorter dimension) of the branch portion 136 is preferably 0.8 to 5 μm (more preferably, 1.3 to 3 μm). If the width is less than 0.8 μm, faulty disconnection may be inclined to occur. On the other hand, if the width exceeds 5 μm, liquid crystal molecules may not be aligned in the direction extending towards the branch portion 136, and in that case, alignment is not performed properly.

The width (the shorter dimension) of the slit 137 is preferably 0.8 to 5 μm (more preferably, 1.3 to 3 μm). If the width is less than 0.8 μm, it may be difficult to form slits 137 uniformly. On the other hand, if the width exceeds 5 μm, a wall of electrical field may be formed at the slit portion (slit 137), and, in that case, the alignment at the slit portion may be divided into a plurality of domains, and a desired alignment might not be obtained.

The openings (slits 137) need to be formed at least in respective pixels. The openings may optionally be formed outside the pixels, i.e., in the light-shielding region.

Below, the method for manufacturing the liquid crystal display device of the present embodiment is described.

First, with a generally available method, constituting members, other than the polymer, of the matrix substrate 110, and constituting members, other than the polymer, of the opposite substrate 130 are manufactured. The matrix substrate 110 and the opposite substrate 130 are both produced out of a large substrate. That is, a plurality of matrix substrates 110 are produced out of a single large substrate (hereinafter also referred to as “first large substrate”), and a plurality of opposite substrates 130 are produced out of a single large substrate (hereinafter also referred to as “second large substrate”). Below, the portions of the first and second large substrates that become the substrates 110 and 130, respectively, are referred to as “panel regions.”

In each of the panel regions of the second large substrate, a first opposite electrodes 132 is formed. The first opposite electrodes 132 are formed unitarily, and therefore are connected to each other. Also, in each of the panel regions of the second large substrate, a second opposite electrode 134 is formed. The second opposite electrodes 134 are formed unitarily and therefore are connected to each other. Further, in the outer periphery of the second large substrate, a first wiring (not shown) and a second wiring (not shown) are formed. The first wiring is connected to the respective first opposite electrodes 132, and the second wiring is connected to the respective second opposite electrodes 134. As a result, all the first opposite electrodes 132 are electrically connected to the first wiring, and all the second opposite electrodes 134 are electrically connected to the second wiring.

Next, a sealing member is applied on the frame region (the region bordering the display region) of the first large substrate, and the liquid crystal composition is dripped into the region bordered by the sealing member using an applicator such as a dispenser. The liquid crystal composition is a nematic liquid crystal material with negative dielectric constant anisotropy, in which a polymerizable component such as monomer and oligomer has been added. The polymerizable component is not particularly limited, and it may be an optically polymerizable monomer or a thermally polymerizable monomer, for example. Here, it is assumed that a thermally polymerizable monomer is used in an example described. Specifically, the polymerizable component may be Dainippon Ink's liquid crystal monoacrylate monomer (UCL-001-K1), for example. Polymerizable component additive amount in the liquid crystal composition is preferably 1.0 to 5.0 (more preferably, 1.5 to 2.5) weight percent. If the additive amount is less than 1.0 weight percent, a desired pretilt angle may not be obtained. In that case, the response speed may slow down and a desired alignment may not be achieved, which are unfavorable consequences. On the other hand, if the additive amount exceeds 5.0 weight percent, polymerizable components such as monomer may remain in the liquid crystal layer 150 after exposure, and, as a result, permanent faulty burn-in due to the re-solidification of the polymerizable component residue may occur.

Next, the second large substrate is bonded to the first large substrate onto which the liquid crystal composition has been dripped. It should be noted that the processes to this stage after the sealing member application are conducted in vacuum.

Next, the bonded first and the second large substrates are placed back into the atmosphere. Then, the liquid crystal composition diffuses under the atmospheric pressure within the space enclosed by the first large substrate, the second large substrate, and the sealing member.

Next, a UV light source is moved along the sealing member to radiate the UV light on the sealing member and cure the sealing member. Thus, the diffused liquid crystal composition is sealed in the space between the first and second large substrates. The cell gap is preferably 2 to 4 (more preferably, 2.5 to 3.5) μm.

Next, the first opposite electrode 132 and the second opposite electrode 134 are set to voltages that are different from each other using the first wiring and the second wiring. Further, pixel switching TFTs are turned on and an AC voltage is applied on the pixel electrode 113. Thus, an electrical field is generated by the second opposite electrode 134 having slits 137, and with this electrical field, the liquid crystal molecules can be tilted to desired directions. That is, the second opposite electrode 134 having slits 137 can regulate the alignment using an electrical field.

While the voltage is applied, the liquid crystal layer 150 is irradiated with UV light (ultraviolet ray having an emission line between the wavelengths of 300 and 400 nm, for example). As the radiation parameters, the radiation light intensity may approximately be 50 to 100 mW/cm², the radiation light amount may approximately be 1 to 2 J/cm² (at the I line (365 nm) reference for both). Thus, the light polymerizable monomer contained in the liquid crystal composition is polymerized, and a polymer structure (surface structure composed of the polymer) that regulates (fixes) the tilting direction (alignment direction when a voltage is applied) and the pretilt angles of the liquid crystal molecules are formed on the surface of the vertical alignment films 114 and 140 on the side facing the liquid crystal layer 150. This creates four domains within each of the pixels. The alignment direction angles (directions in which the liquid crystal molecules are aligned) of every domains in the present embodiment are 45°, 135°, 225°, and 315°, for example, to match with the extending directions of the slits 137.

The voltage applied to the first opposite electrode 132 and the second opposite electrode 134 when the polymerizable component is polymerized is not particularly limited. Basically, however, it only needs to be set to satisfy the relationship of (absolute value of the voltage of the first opposite electrode 132)<(absolute value of the voltage of second opposite electrode 134). For example, the first opposite electrode 132 can be connected to GND (0V), and an AC voltage with the center voltage of GND (0V) can be applied on the second opposite electrode 134.

On the other hand, an equal voltage may be applied on the first opposite electrode 132 and the second opposite electrode 134 when polymerizing the monomer. In this case, however, alignment might not be regulated with the electrical field generated by the second opposite electrode 134 having openings (slits 137), and possibly desired alignment angles cannot be obtained.

The following voltage application scheme may be applied to the first opposite electrode 132 and the second opposite electrode 134. That is, the first opposite electrode 132 is formed into a sheet (planar shape) to cover approximately the entire second large substrate. Also, the second opposite electrode 134 may be formed into a sheet (planar shape) to cover approximately the entire second large substrate, but with openings (slits 137). Then, in the outer periphery of the second large substrate, a voltage application route may directly be connected to the respective first opposite electrode 132 and second opposite electrode 134 to apply voltages on the electrodes.

Next, with no voltage applied to the liquid crystal layer 150, the first and the second large substrates are exposed under the fluorescent light to remove the polymerizable component residue in the liquid crystal layer 150. Then, processes such as cell separation, polarizing plate bonding, and backlight assembly are conducted to complete a liquid crystal display device of the present embodiment.

After the polymerizable components are polymerized, for a normal display, the first opposite electrode 132 and the second opposite electrode 134 are set to the same potential (common potential), and a prescribed data signal is sent to the pixel electrode 113.

Thus, according to the present embodiment, the first opposite electrode 132 and the second opposite electrode 134 are set to different potentials when the polymerizable component is polymerized. Consequently, compared to the case in which a conventional fishbone type insulating film is used, the alignment can be controlled more reliably.

The first opposite electrode 132 is arranged such that it overlaps the slits 137 of the second opposite electrode 134 when the substrates 110 and 130 are observed in a plan view. That is, the first opposite electrode 132 is present under the slit 137 of the second opposite electrode 134. Further, no opening such as a slit is formed in the pixel electrode 113. As a result, compared to the case in which a conventional fishbone-shaped electrode and/or insulating film are used, a higher effective voltage can be applied to the liquid crystal layer 150. Accordingly, a higher transmittance can be achieved.

Also, it is the second opposite electrode 134, a transparent electrode, that is formed into a fishbone shape, and further, alignment is regulated by the electrical field when the polymerizable component is polymerized. The second opposite electrode 134, therefore, only needs to have the least film thickness necessary to function as an electrode. Thus, any surface unevenness formed by the presence of a fishbone-shaped structure can be made smaller than in the case where an insulating film is patterned into a fishbone shape. As a result, the amount of light leakage at the uneven surface spot can be reduced, and accordingly, the contrast characteristics can be maintained.

Also, because the second opposite electrode 134 can be formed on the opposite substrate 130, the manufacturing process for the matrix substrate 110 does not become complicated.

Also, the first opposite electrode 132 is disposed to fill all the spaces in the slits 137 of the second opposite electrode 134, i.e., to overlap the entire spaces in the slits 137 of the second opposite electrode 134 when the substrates 110 and 130 are observed in a plan view. This arrangement therefore can provide a higher transmittance compared to the case where the first opposite electrode 132 is disposed to partially overlap the spaces in the slits 137 of the second opposite electrode 134.

Thus, the first opposite electrode 132 only needs to be formed to fill the openings (slits 137) that are formed in a region at least overlapping the pixels. The shape of the first opposite electrode 132 therefore is not particularly limited. For example, the first opposite electrode 132 may be patterned into the same planar shape with the slits 137 of the second opposite electrode 134, i.e., into the fishbone shape. However, preferably, the first opposite electrode 132 does not have any opening, and is formed into a planar shape when observed in a plan view to cover the display region. Thus, by evenly forming the first opposite electrode 132 over the opposite substrate 130, one manufacturing process can be eliminated. Also, misalignment between the patterns of the first opposite electrode 132 and the second opposite electrode 134 caused by the misalignment in patterning can be suppressed.

In the present invention, the shape of the openings in the second opposite electrode is not particularly limited to a fishbone shape, and can be determined according to the desired viewing angle characteristics.

The present application claims priority to Patent Application No. 2009-115971 filed in Japan on May 12, 2009 under the Paris Convention and provisions of national law in a designated State. The entire contents of which are hereby incorporated by reference.

### DESCRIPTION OF REFERENCE CHARACTERS

110 matrix substrate
111, 131 glass substrate
112 insulating layer (interlayer insulating film)
113 pixel electrode
114, 140 vertical alignment film
130 opposite substrate
132 first opposite electrode
133 insulating layer
134 second opposite electrode
135 trunk portion
136 branch portion
137 slit
138 trunk slit
139 branch slit
150 liquid crystal layer

1. A liquid crystal display device, comprising a pair of substrates and a liquid crystal layer held between said pair of substrates,
one of said pair of substrates comprising pixel electrodes,
the other of said pair of substrates comprising a first opposite electrode, an insulating layer formed on said first opposite electrode, and a second opposite electrode formed on said insulating layer, and
said second opposite electrode having an opening,
wherein said opening overlaps at least with a pixel when said pair of substrates are observed in a plan view, and
wherein said first opposite electrode overlaps at least part of said opening in the pixel when said pair of substrates are observed in a plan view.

2. The liquid crystal display device according to claim 1, wherein said first opposite electrode overlaps the entire opening in the pixel when said pair of substrates are observed in a plan view.

3. The liquid crystal display device according to claim 1, wherein said first opposite electrode has a planar shape.

4. The liquid crystal display device according to claim 1, wherein said opening includes a plurality of slits.

5. The liquid crystal display device according to claim 4, said second opposite electrode includes a trunk portion formed along a border between adjacent pixels and a plurality of branch portions extending from said trunk portion, wherein said plurality of slits and said plurality of branch portions are arranged alternately.

6. The liquid crystal display device according to claim 1, wherein the liquid crystal mode of said liquid crystal display device is a vertical alignment mode.

7. The liquid crystal display device according to claim 1, wherein said liquid crystal layer contains nematic liquid crystal molecules having negative dielectric constant anisotropy.

8. The liquid crystal display device according to claim 1, said pair of substrates further comprises a polymer formed thereon on a side facing said liquid crystal layer, wherein said polymer is formed by polymerizing the polymerizable component added to said liquid crystal layer while a voltage is applied on said liquid crystal layer.
